(19) United States
(12) Patent Application Publication
(10) Pub. No.: US 2009/0298561 A1
(43) Pub. Date: Dec. 3, 2009

(54) SLIDING-TYPE MECHANISM WITH A SEMI-AUTOMATIC OPENING FUNCTION

(76) Inventor: Chan-Jung Kang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/256,472

(22) Filed: Oct. 23, 2008

(30) Foreign Application Priority Data
May 28, 2008 (TW) 097209335

(51) Int. Cl. H04M 1/02

(52) U.S. Cl. 455/575.4; 379/433.12

(57) ABSTRACT

A sliding-type mechanism includes a fixing component, a sliding component disposed on a side of the fixing component in a slidable manner relative to the fixing component, and an elastic structure. One end of the elastic structure is pivoted to the fixing component and the other end of the elastic structure is pivoted to the sliding component. The elastic structure includes a plurality of winding parts for rotating due to elastic compression so as to drive the sliding component to move to a second position in a direction when the sliding component is pushed at a predetermined distance from a first position in the direction.

### BACKGROUND OF THE INVENTION

1. Field of the Invention

The present invention relates to a sliding-type mechanism, and more particularly, to a sliding-type mechanism with a semi-automatic opening function.

2. Description of the Prior Art

In highly developed information communication systems in the modern information society, the utilization of a convenient and lightweight mobile phone device has become a common means of communication in our daily life. People can easily exchange and share information, experiences, and opinions through the convenience of the mobile phone device. The development and usage of mobile phones has increased tremendously. The mobile phone progressed tremendously in recent years and various types of mobile phones are continuously developed. The increasing utilization has created a demand in production, as the mobile phones are becoming common causing the technology of mobile phones to mature with the trend moving towards smaller multi-functional phones. The important issue now is how to design a more convenient mobile phone for the user to utilize.

In opening design of the mobile phone in the market, part of the opening design of the mobile phone utilizes a sliding-type construction. This was especially evident in the high-end segment of the mobile phone market. The slide construction mobile phone is smaller in comparison to the size of a straight vertical mobile phone. Additionally, slide construction mobile phones have keypads with a wider surface area. On the other hand, the slide mechanism of the slide construction mobile phone operates predominantly in a manual fashion. If a handset is long and needs a longer opening distance, it appears to be inconvenient for the user. This is especially evident when the user with a small palm wishes to perform the opening function utilizing just one hand, a phenomenon may occur where the phone cannot be not completely open, and this creates inconvenience for the user operating the device. Thus the design of semi-automatic opening mechanism is developed. Generally, the design of semi-automatic opening mechanism often uses elastic elements, such as springs or torsional springs, to drive the sliding cover. However, there is a drawback of stress concentration for using springs as driver elements. Using the torsional spring as the driver elements improves the drawback of stress concentration. For example, Taiwan patent No. 325679 discloses an improvement of sliding-cover structure that utilizes two elastic elements (two torsional springs) to drive an upper cover. One end of the elastic element is pivoted to the upper cover, and the other end of the elastic element is pivoted to a bottom cover. In order to changing the relative position between the upper cover and the bottom cover, the upper cover is pushed so that the elastic element connected to the upper cover rotates. Please refer to FIG. 1 and FIG. 2. FIG. 1 and FIG. 2 are diagrams of a moving route of a single torsional spring in the prior art. Two ends of the torsional spring 10 are pivoted to a sliding component 12 and a fixing component 14 respectively. While the sliding component 12 moves form a location shown in FIG. 1 to a location shown in FIG. 2, the torsional spring 10 rotates due to elastic compression and results in the elastic deformation as shown in the figure. However, the prior art shows as the form of the single torsional spring and needs a longer route and a wider mechanical space (width D1) to provide the rotating freedom of the single torsional spring. If the torsional spring 10 is installed as shown in FIG. 3 so that its winding part is close to an edge of the sliding component 12 and the fixing component 14 without reserving enough mechanical space, the torsional spring 10 protrudes out of the sliding component 12 and the fixing component 14 partially while rotating by elastic compression. It causes that the torsional spring 10 fails to rotate due to interference or the torsional spring 10 exposes out of the mechanism of the sliding component 12 and the fixing component 14. Moreover, the torsional spring 10 buckles easily due to longer moving route. The elastic controllability is limited, and the conventional mechanism provides less elastic force. The elastic structure may be destroyed due to local stress concentration and elastic fatigue.

### SUMMARY OF THE INVENTION

According to the claimed invention, a sliding-type mechanism includes a fixing component, a sliding component disposed on a side of the fixing component in a slidable manner relative to the fixing component, and an elastic structure. One end of the elastic structure is pivoted to the fixing component, and the other end of the elastic structure is pivoted to the sliding component. The elastic structure includes the plurality of winding parts which rotates by the elastic compression after the sliding component moves at a predetermined distance from the first position in a direction so as to drive the sliding component to a second position in the same direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are diagrams of a moving route of a single torsional spring in the prior art.

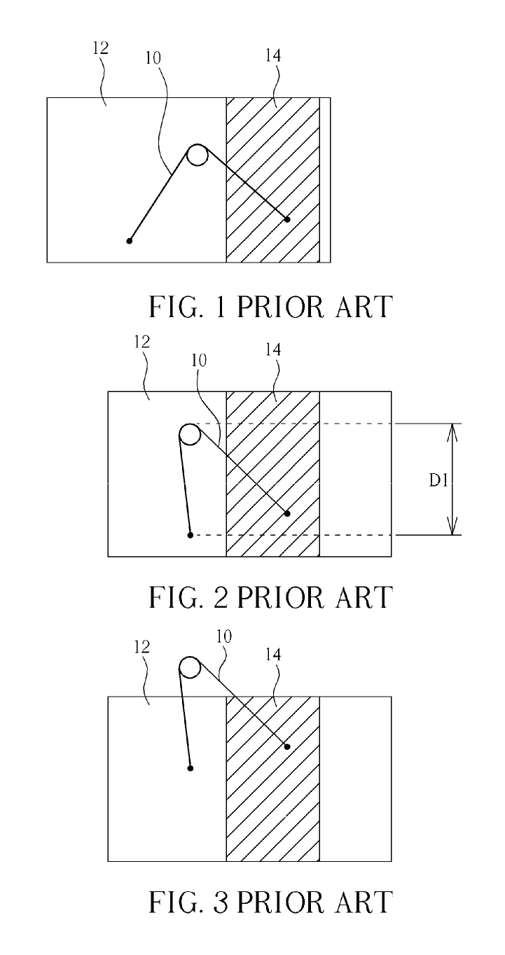

FIG. 4 to FIG. 6 are diagrams of a sliding-type mechanism at different positions according to a first embodiment of the present invention.

FIG. 7 to FIG. 8 are diagrams of a moving route of an elastic structure of the present invention.

FIG. 9 to FIG. 11 are diagrams of a sliding-type mechanism at different positions according to a second embodiment of the present invention.

FIG. 12 to FIG. 13 are diagrams of different elastic structures according to a third embodiment and a fourth embodiment of the present invention.

### DETAILED DESCRIPTION

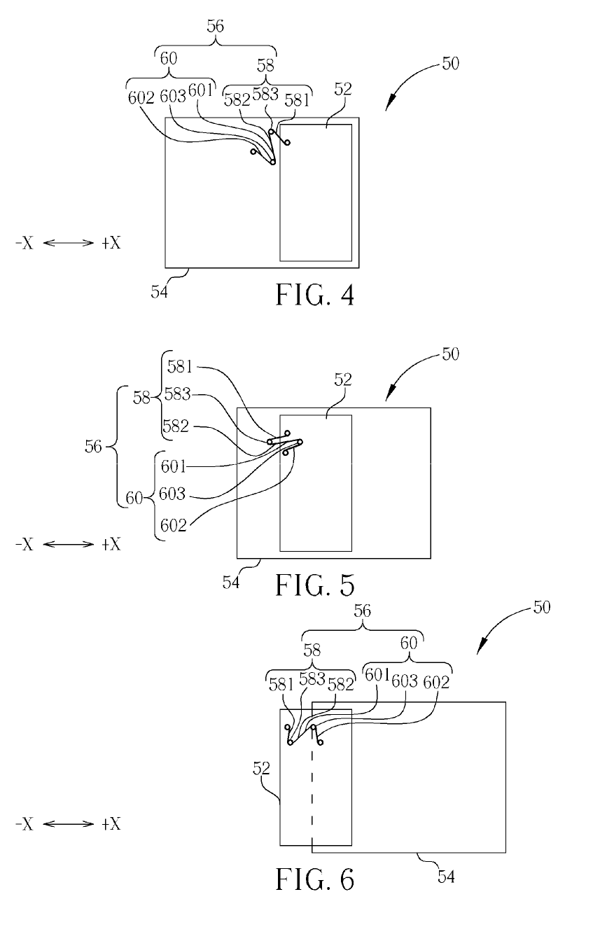

Please refer to FIG. 4 to FIG. 6, FIG. 4 to FIG. 6 are diagrams of a sliding-type mechanism 50 at different positions according to a first embodiment of the present invention. The sliding-type mechanism 50 can be applied to a portable device, such as a mobile phone. The sliding-type mechanism 50 includes a fixing component 52 which can be a fixed element in the portable device, such as a base, a sliding component 54 which can be disposed on a side of the fixing component 52 in a slidable manner relative to the fixing component 52, such as a sliding cover of the mobile phone, and an elastic structure 56. One end of the elastic structure 56 is pivoted to the fixing component 52, and the other end of the elastic structure 56 is pivoted to the sliding component 54. In this embodiment, the elastic structure 56 includes a first elastic element 58 which includes a first section 581 pivoted to the fixing component 52 at one end, a second section 582, and a first winding part 583 connected to the first section 581 and the second section 582. The first winding part 583 is formed at a first curvature. The elastic structure 56 further includes a second elastic element 60 which includes a third section 601 connected to the second section 582 of the first elastic element 581, a fourth section 602 pivoted to the sliding component 54 at one end, and a second winding part 603 connected to the third section 601 and the fourth section 602. The second winding part 603 is formed at a second curvature. The direction of the first curvature is opposite to the direction of the second curvature substantially. The first elastic element 58 and the second elastic element 60 can be a torsional spring respectively. The first elastic element 58 and the second elastic element 60 can be monolithically formed.

As shown in FIG. 4, while the sliding component 54 is located at a first position relative to the fixing component 52, that is the sliding component 54 has not been pushed, the first section 581 of the first elastic element 58 is parallel to the fourth section 602 of the second elastic element 60 substantially, and the second section 582 of the first elastic element 58 is parallel to the third section 601 of the second elastic element 60 substantially. When a user pushes the sliding component 54 at a predetermined distance in −X direction so that the sliding component 54 shifts form the first position relative to the fixing component 52 to a position as shown in FIG. 5, the second section 582 of the first elastic element 58 aligns with the third section 601 of the second elastic element 60 substantially, and the first section 581 of the first elastic element 58 and the fourth section 602 of the second elastic element 60 are parallel to the second section 582 of the first elastic element 58 and the third section 601 of the second elastic element 60 substantially. At this time, the first elastic element 58 and the second elastic element 60 rotate by the elastic compression so as to drive the sliding component 54 to a second position in −X direction as shown in FIG. 6. At this time, the first section 581 of the first elastic element 58 is parallel to the fourth section 602 of the second elastic element 60 substantially, and the second section 582 of the first elastic element 58 aligns with the third section 601 of the second elastic element 60 substantially so as to accomplish the opening motion of the sliding component 54. On the other hand, if the user wants to close the sliding component 54, the user can push the sliding component 54 in +X direction so that the sliding-type mechanism 50 transforms sequentially as shown in FIG. 6, FIG. 5, and FIG. 4. The working principle is the same as the above-mentioned one of the opening motion and the detailed description is omitted herein for simplicity. In conclusion, the elastic structure 56 produces a reacting force while the user opens or closes the sliding-type mechanism 50. The reacting force keeps the elastic structure 56 stationary until the elastic structure 56 is moved over a predetermined distance so as to prevent unintentional action for pushing the sliding component 54. It means that after the sliding-type mechanism 50 is transferred from the first position as shown in FIG. 4 to the position as shown in FIG. 5 or transferred from the second position as shown in FIG. 6 to the position as shown in FIG. 5, the sliding-type mechanism 50 executes the motion of opening or closing automatically. The mechanism of the present invention creates convenience on operating interface so that the user can operate the portable device comfortably.

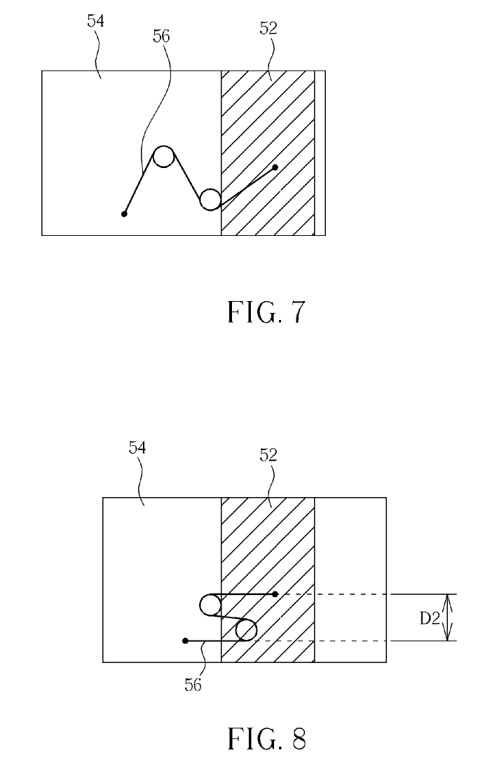

Please refer to FIG. 7 and FIG. 8. FIG. 7 and FIG. 8 are diagrams of a moving route of the elastic structure 56 according to a first embodiment of the present invention. When the sliding component 54 moves from a position as shown in FIG. 7 to a position as shown in FIG. 8, the elastic structure 56 rotates by elastic compression and deforms elastically. The elastic structure is formed with the plurality of torsional springs so that it merely needs smaller mechanical space (a width D2 is smaller than the width D1) to provide rotating freedom of the plurality of torsional springs. In other words, the elastic structure of the present invention merely needs smaller mechanical space but achieves the longer route than the route of the conventional single torsional spring in the prior art. Besides, the elastic structure of the present invention has preferred elastic controllability and supplies larger elastic force so that there is no need to assemble an additional sustaining or guiding structure for avoiding buckling. The present invention also can prevent destroying the elastic structure due to the local stress concentration or the elastic fatigue.

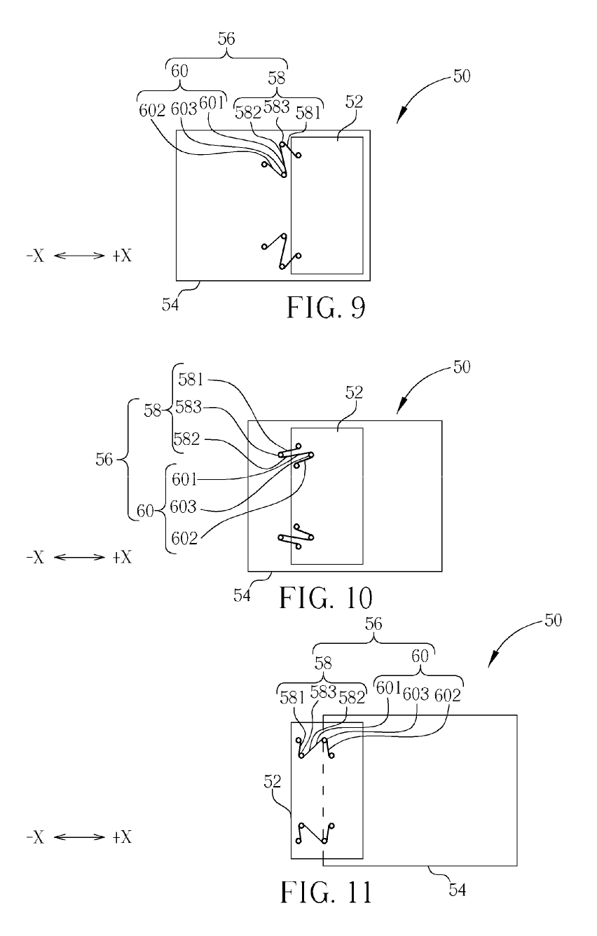

Moreover, the number of the first elastic element 58 and the second elastic element 60 of the elastic structure 56 is not limited to one set. That is, the number and the disposition of the elastic elements are not limited to the above-mentioned embodiment. For example, please refer to FIG. 9 to FIG. 11, FIG. 9 to FIG. 11 are diagrams of the sliding-type mechanism 50 at different positions according to a second embodiment of the present invention. The first elastic elements 58 and the second elastic elements 60 can be disposed on two sides of the fixing component 52 and the sliding component 54 respectively. The working principle of the second embodiment is the same as the working principle of the first embodiment and the detailed description is omitted herein for simplicity.

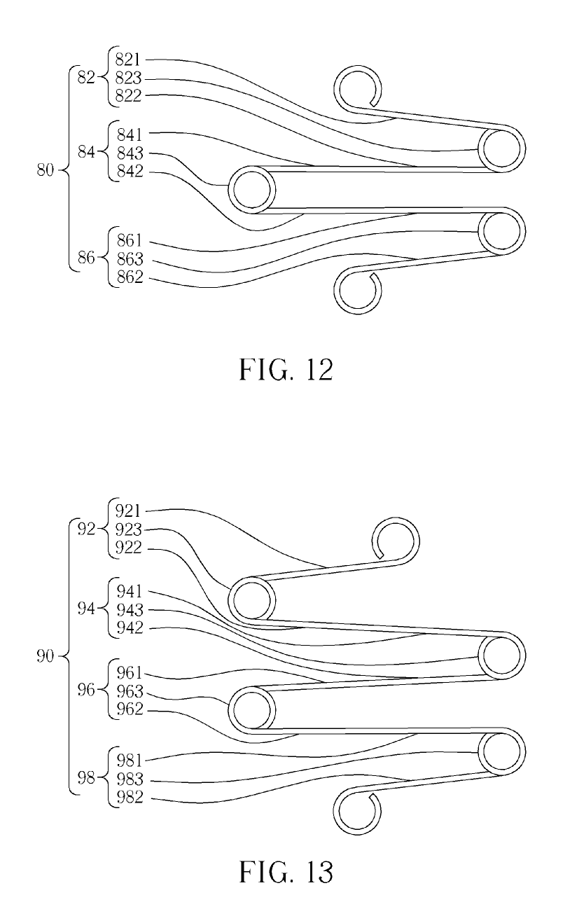

In addition, the main structural characteristic of the elastic structure of the present invention includes a plurality of winding parts. The elastic structure of the present invention can be a combination of several sets of the elastic elements and is not limited to two sets of the above-mentioned embodiment. For example, please refer to FIG. 12 and FIG. 13. FIG. 12 and FIG. 13 are diagrams of different elastic structures according to a third embodiment and a fourth embodiment of the present invention respectively. As shown in FIG. 12, an elastic structure 80 includes a first elastic element 82 which includes a first section 821 pivoted to the fixing component 52, a second section 822, and a first winding part 823 connected to the first section 821 and the second section 822. The first winding part 823 is formed at a first curvature. The elastic structure 80 further includes a second elastic element 84 which includes a third section 841 connected to the second section 822 of the first elastic element 821, a fourth section 842, and a second winding part 843 connected to the third section 841 and the fourth section 842. The second winding part 843 is formed at a second curvature. The elastic structure 80 further includes a third elastic element 86 which includes a fifth section 861 connected to the fourth section 842 of the second elastic element 84, a sixth section 862 pivoted to the sliding component 54, and a third winding part 863 connected to the fifth section 861 and the sixth section 862. The third winding part 863 is formed at a third curvature. The direction of the first curvature is the same as the direction of the third curvature substantially. The direction of the first and the third curvature is opposite to the direction of the second curvature substantially. The first elastic element 82, the second elastic element 84, and the third elastic element 86 can be a torsional spring respectively. The first elastic element 82, the second elastic element 84, and the third elastic element 86 can be monolithically formed. In conclusion, the elastic structure 80 is a combination of three torsional springs basically. The working principle of the third embodiment is the same as the working principle of the above-mentioned embodiments, and the detailed description is omitted herein for simplicity.

As shown in FIG. 13, an elastic structure 90 includes a first elastic element 92 which includes a first section 921 pivoted to the fixing component 52, a second section 922, and a first winding part 923 connected to the first section 921 and the second section 922. The first winding part 923 is formed at a first curvature. The elastic structure 90 further includes a second elastic element 94 which includes a third section 941 connected to the second section 922 of the first elastic element 92, a fourth section 942, and a second winding part 943 connected to the third section 941 and the fourth section 942. The second winding part 943 is formed at a second curvature. The elastic structure 90 further includes an third elastic element 96 which includes a fifth section 961 connected to the fourth section 942 of the second elastic element 94, a sixth section 962, and a third winding part 963 connected to the fifth section 961 and the sixth section 962. The third winding part 963 is formed at a third curvature. The elastic structure 90 further includes a fourth elastic element 98 which includes a seventh section 981 connected to the sixth section 962 of the third elastic element 96, an eighth section 982 pivoted to the sliding component 54, and a fourth winding part 983 connected to the seventh section 981 and the eighth section 982. The fourth winding part 983 is formed at the fourth curvature. The direction of the first curvature is the same as the direction of the third curvature substantially. The direction of the second curvature is the same as the direction of the fourth curvature substantially. The direction of the first curvature and the third curvature is opposite to the direction of the second curvature and the fourth curvature substantially. The first elastic element 92, the second elastic element 94, the third elastic element 96, and the fourth elastic element 98 can be a torsional spring respectively. The first elastic element 92, the second elastic element 94, the third elastic element 96, and the fourth elastic element 98 can be monolithically formed. In conclusion, the elastic structure 90 is a combination of four torsional springs basically. The working principle of the fourth embodiment is the same as the working principle of the above-mentioned embodiments, and the detailed description is omitted herein for simplicity.

In contrast to the prior art, the elastic structure of the present invention utilizes smaller mechanical space to achieve the same function of semi-automatic opening as the conventional single torsional spring. Besides, the elastic structure of the present invention has preferred elastic controllability and supplies larger elastic force so that there is no need to assemble sustaining or guiding structure additionally for avoiding buckling. The present invention also prevents destroying the elastic structure due to the local stress concentration and the elastic fatigue.

Those skilled in the art will readily observe that numerous modifications and alterations of the device and method may be made while retaining the teachings of the invention.

What is claimed is:

1. A sliding-type mechanism comprising:
a fixing component;
a sliding component disposed on a side of the fixing component in a slidable manner relative to the fixing component; and
an elastic structure, one end of the elastic structure being pivoted to the fixing component and the other end of the elastic structure being pivoted to the sliding component, and the elastic structure comprising a plurality of winding parts for rotating due to elastic compression so as to drive the sliding component to move to a second position in a direction when the sliding component is pushed at a predetermined distance from a first position in the direction.

2. The sliding-type mechanism of claim 1, wherein the elastic structure comprises:
at least one first elastic element comprising:
a first section pivoted to the fixing component;
a second section; and
a first winding part connected to the first section and the second section, the first winding part being formed at a first curvature; and
at least one second elastic element comprising:
a third section connected to the second section of the first elastic element;
a fourth section pivoted to the sliding component; and
a second winding part connected to the third section and the fourth section, the second winding part being formed at a second curvature, and a direction of the first curvature being opposite to a direction of the second curvature.

3. The sliding-type mechanism of claim 2, wherein the first elastic element is a torsional spring.

4. The sliding-type mechanism of claim 2, wherein the second elastic element is a torsional spring.

5. The sliding-type mechanism of claim 2, wherein the first elastic element and the second elastic element are monolithically formed.

6. The sliding-type mechanism of claim 2, wherein the first section is parallel to the third section substantially and the second section is parallel to the fourth section substantially when the sliding component is at the first position relative to the fixing component.

7. The sliding-type mechanism of claim 2, wherein the first section is parallel to the fourth section substantially and the second section aligns with the third section when the sliding component is at the second position relative to the fixing component.

8. The sliding-type mechanism of claim 1, wherein the elastic structure comprises:
at least one first elastic element comprising:
a first section pivoted to the fixing component;
a second section; and
a first winding part connected to the first section and the second section, the first winding part being formed at a first curvature;
at least one second elastic element comprising:
a third section connected to the second section of the first elastic element;
a fourth section; and
a second winding part connected to the third section and the fourth section, the second winding part being formed at a second curvature;
at least one third elastic element comprising:
a fifth section connected to the fourth section of the second elastic element;
a sixth section pivoted to the sliding component; and
a third winding part connected to the fifth section and the sixth section, the third winding part being formed at a third curvature;
a direction of the first curvature being identical to a direction of the third curvature, a direction of the first curvature and the third curvature being opposite to a direction of the second curvature.

9. The sliding-type mechanism of claim 8, wherein the first elastic element, the second elastic element, and the third elastic element are a torsional spring respectively.

10. The sliding-type mechanism of claim 8, wherein the first elastic element, the second elastic element, and the third elastic element are monolithically formed.

11. The sliding-type mechanism of claim 1, wherein the elastic structure comprises:
at least one first elastic element comprising:
a first section pivoted to the fixing component;
a second section; and
a first winding part connected to the first section and the second section, the first winding part being formed at a first curvature;
at least one second elastic element comprising:
a third section connected to the second section of the first elastic element;
a fourth section; and
a second winding part connected to the third section and the fourth section, the second winding part being formed at a second curvature;
at least one third element comprising:
a fifth section connected to the fourth section of the second elastic element;
a sixth section; and
a third winding part connected to the fifth section and the sixth section, the third winding part being formed at a third curvature; and
at least one fourth element comprising:
a seventh section connected with the sixth section of the third elastic element;
a eighth section pivoted to the sliding component; and
a fourth winding part connected to the seventh section and the eighth section, the fourth winding part being formed at a fourth curvature;
a direction of the first curvature being identical to a direction of the third curvature, a direction of the second curvature being identical to a direction of the fourth curvature, a direction of the first curvature and the third curvature being opposite to a direction of the second curvature and the fourth curvature.

12. The sliding-type mechanism of claim 11, wherein the first elastic element, the second elastic element, the third elastic element, and the fourth elastic element are a torsional spring respectively.

13. The sliding-type mechanism of claim 11, wherein the first elastic element, the second elastic element, the third elastic element, and the fourth elastic element are monolithically formed.

14. The sliding-type mechanism of claim 1, wherein the sliding component is a sliding cover of a mobile phone.
